(19) United States
(12) Patent Application Publication
(10) Pub. No.: US 2026/0041070 A1
(43) Pub. Date: Feb. 12, 2026

(54) SUBSTRATE STRUCTURE FOR A TANK FOR CRUSTACEANS

(71) Applicant: LAGOSTA SA, St-Prex (CH)

(72) Inventors: Christophe Maier, St-Prex (CH); Sebastien Ferraz, La Colle sur Loup (FR)

(21) Appl. No.: 19/101,473

(22) PCT Filed: Aug. 7, 2023
(86) PCT No.: PCT/EP2023/071801

§ 371 Date: Feb. 5, 2025

(30) Foreign Application Priority Data
Aug. 9, 2022 (CH) CH000939/2022

(51) Int. Cl. A01K 61/73; A01K 61/59; A01K 63/00

(52) U.S. Cl. CPC A01K 61/73; A01K 61/59; A01K 63/006

(57) ABSTRACT

Disclosed herein is a substrate structure (1) for a tank (12) for crustaceans, wherein the substrate structure comprises at least two support gratings (2) arranged parallel to each other. The substrate structure further comprises at least two interspacing units (3) arranged between the two support gratings for spacing the two support gratings at a distance of at least 20 mm, such that at least two floors (4) are formed, which provide support for the crustaceans. Further disclosed are a tank entity (11) comprising the substrate structure and use of the substrate structure for holding crustaceans.

### FIELD OF THE INVENTION

The present disclosure relates to a substrate structure for a tank for crustaceans and a tank entity comprising such a substrate structure. The disclosure also relates to use of such a substrate structure.

### BACKGROUND OF THE INVENTION

A crustacean is an animal with a hard shell and several pairs of legs, which usually lives in water. Animals like crabs, lobsters, spiny lobsters or shrimps are considered crustaceans. The different crustaceans are used as seafood in different varieties and many of the different kinds of crustaceans are considered a delicacy on different parts of the world. Widely known as delicacy are in particular crabs, lobsters, spiny lobsters and shrimps. This delicacy status of these animals led to a high demand on the world markets for these animals. Many of these animals are therefore heavily overfished.

Many crustaceans are farmed in tanks or aquariums for various reasons and purposes, including for wildlife preservation, for production of seafood and for isolating products from molts generated from the crustaceans. There is a general desire to make the farming process of crustaceans more efficient and increase the health and well-being of the crustaceans being farmed. To this end, various developments have been made to create an ideal environment for the crustaceans inside the tanks. These include objects which are placed inside the tank, such as rocks, sand, plants, etc.

Crustaceans undergo a molt cycle which is repeated often when the crustaceans are immature and less often when they are mature. During the molting process, in particular during shedding of the old exoskeleton, the animal is vulnerable. Difficulties may occur during the molting process, which may result in death of the animal (molt death syndrome).

### SUMMARY OF THE INVENTION

The known methods for farming crustaceans and the tanks used in these methods suffer from a range of disadvantages, including a limited density of crustaceans that may be farmed in a given tank volume. A further disadvantage is that a high mortality of crustaceans is observed during farming, in particular a high mortality associated with the molting process of the animals. Furthermore, there is still a need to create tanks for crustaceans that create a good habitat for the animals. A good habitat includes increasing the health and well-being of the animals.

Furthermore, there is still a need to create tanks and farming methods that increase the growth of individual crustaceans and of the entire population of crustaceans being farmed. A further need is to increase the health of the crustaceans in order to enhance their chances of survival after releasing them into the wild, and to increase food safety of the crustaceans farmed for seafood purposes.

It is an object of the present disclosure to provide a substrate structure for a tank for crustaceans, a tank entity comprising such a substrate structure, a use of such a substrate structure and a method of holding crustaceans. In particular, it is an object of the present disclosure to provide a substrate structure, a tank entity, a use of the substrate structure and a method of holding crustaceans, which substrate structure, tank entity, use and method which do not have at least some of the disadvantages of the prior art.

According to the present disclosure, these objects are addressed by the features of the independent claims. In addition, further advantageous embodiments follow from the dependent claims and the description.

In advantageous embodiments, a substrate structure for a tank for crustaceans is provided, which substrate structure provides support for the crustaceans, particularly during molting. By providing support for the crustaceans, it is easier for the crustaceans to extricate themselves from the molt. As a result, the health of the crustaceans is enhanced and the survival rate of the crustaceans, in particular during the molting process, is increased.

In further advantageous embodiments, a substrate structure is provided which creates a good habitat for the crustaceans. A good habitat contributes to the well-being of the animals and increases the growth of the individuals and the population. A good habitat may emulate the natural environment of the animals.

In further advantageous embodiments, a substrate structure is provided which allows the crustaceans to be farmed at a high density.

In a first aspect, the present disclosure relates to a substrate structure for a tank for crustaceans. The substrate structure comprises at least two support gratings arranged parallel to each other. The substrate structure further comprises at least two interspacing units arranged between the two support gratings for spacing the two support gratings at a distance of at least 20 mm, such that two floors are formed, which provide support for the crustaceans.

The substrate structure is a three-dimensional object. In explaining the substrate structure in further detail, reference will be made to a three-dimensional Cartesian coordination system with an x axis, a y axis and a z axis. To provide a better understanding, the plane defined by the x axis and y axis is labelled as a horizontal plane and the z axis will be labelled as defining a vertical direction. However, these terms merely serve illustration purposes.

The substrate structure is suitable for being placed inside a tank for crustaceans, particularly spiny lobsters. The tank may be closed to the environment, open to the environment or partially open to the environment. The substrate structure volume is determined in dependence of the size of the tank. The volume of the substrate structure is smaller compared to the volume of the tank, for example less than 80% of the volume of the tank. In an embodiment, the substrate structure has a volume of less than 3′000 mm×3′000 mm×3′000 mm. In an embodiment, the substrate structure has a volume of more than 100 mm×100 mm×100 mm.

A tank as used herein is a container that may be filled with water and that may hold crustaceans. A tank may, for example, be used for farming crustaceans.

A support grating as used herein is a grating for providing support, particularly for providing support to crustaceans, such as during molting. A grating as used herein is a structure comprising a plurality of bars, wherein the bars cross each other to define a plurality of holes. It is understood that not every bar crosses every other bar. Rather, for example, some of the bars may be arranged parallel to each other and may be crossed by the remaining bars. In an embodiment, the bars are arranged at regular intervals. In a further embodiment, the holes are arranged at regular intervals. In an embodiment, the grating is a lattice.

In an embodiment, the holes are through-holes. In an embodiment, the holes are cylindrical or cuboid, particularly rectangularly cuboid. As an example, the holes may be defined by a cross section and a height. As an example, the cross section may be arranged horizontally and the height may extend vertically. The height typically corresponds to a thickness of the support grating. The cross section may, for example, be oval, such as circular or elliptical, or it may be rectangular, such as quadratic. In some embodiments, the holes are cylindrical with a circular cross section.

In an embodiment, the holes are oval, such as circular or elliptical. In a further embodiment, the holes are rectangular, such as quadratic.

In an embodiment, the support gratings have holes sized from 1 mm² to 10′000 mm², preferably from 16 mm² to 900 mm², preferably 100 mm². In particular, in an embodiment, the support gratings have holes sized from 1 mm×1 mm to 100 mm×100 mm, preferably from 4 mm×4 mm to 30 mm×30 mm, preferably 10 mm×10 mm. These sizes may, for example, relate to the cross section of the hole. In an embodiment, the holes are rectangular, having a width and a length, and the ratio of the width and length ranges from 0.5:1 to 1:0.5, preferably 1:1.

One advantage of these embodiments is that if the holes have a size in the indicated ranges, the substrate structure was found to provide particularly good support for crustaceans, particularly macro-crustaceans such as lobsters. The holes are adequately sized to receive body extremities of the crustacean, such as legs, antennae or, if present, parts of the claws. Additionally, the holes are adequately sized to allow sufficient water flow and not to disrupt any currents. This also means that the substrate structure does not move significantly as a result of any currents or water flows. Consequently, the substrate structure according to these embodiments is associated with a high degree of well-being for the crustaceans. In an embodiment, the holes are sized in dependence of a level of development/level of growth of the crustaceans.

In an embodiment, the support gratings and the floors are arranged horizontally. In an embodiment, at least one support grating, preferably from one to ten support gratings, form a floor. In an embodiment, the number of support gratings is tank size dependent. In an embodiment, the support gratings of each floor are arranged in a plane. In an embodiment, the support gratings forming each floor are directly adjacent to each other, preferably connected to each other.

In an embodiment, the substrate structure comprises a plurality of the support gratings forming three or more, preferably from three to six, of the floors, wherein the floors are spaced apart by a plurality of the interspacing units. In an embodiment, the interspacing units are connected to the support gratings, preferably by way of a fiber. The fiber is, for example, arranged through the holes of the support gratings.

In an embodiment, the floors are spaced apart at a distance from 20 mm to 300 mm, particularly from 25 mm to 300 mm, particularly from 50 mm to 300 mm, more particularly from 50 mm to 200 mm. In an embodiment, in particular for holding adult lobsters, more particularly adult spiny lobsters, the floors are spaced apart at a distance from 70 mm to 200 mm, particularly from 100 mm to 150 mm. In an embodiment, in particular for holding juvenile lobsters, more particularly juvenile spiny lobsters, the floors are spaced apart at a distance from 20 mm to 100 mm, particularly from 32 mm to 63 mm. In an embodiment, in particular for holding broodstock lobsters, more particularly broodstocks spiny lobsters, the floors are spaced apart at a distance from 45 mm to 200 mm, particularly from 63 mm to 100 mm. In an embodiment, the respective crustaceans, such as the adult lobsters, the juvenile lobsters and/or the broodstock lobsters are held in a tank comprising a substrate structure according to the previously described embodiments.

The distances indicated in the previous paragraph were found to provide a good habitat for crustaceans, particularly spiny lobsters. As an example, the distances ensure that the floors provide protection for the animals and that a sense of protection is conveyed to the animals. The distances further allow the animals to use the substrate structure effectively to efficiently extricate themselves of their exoskeleton during molting. A further advantage is that not only are shelters and hiding places created which are adapted to the size of the individual, but also more communal shelters are created which were found to be beneficial for the crustaceans at a social level but also especially during the pre and post-molt period when the individual is vulnerable.

In an embodiment, each floor has a top surface and a bottom surface opposite the top surface. The top and bottom surfaces typically extend horizontally, i.e. in the x- and y-direction. In an embodiment, each floor has a width and a length, which may define the top surface and the bottom surface. As an example, the width of the floor may correspond to the x-direction and the length may correspond to the y-direction. In an embodiment, each floor has a thickness, which may, e.g., extend along the z-direction.

In an embodiment, the distance at which the floors are spaced apart extends in a vertical direction. In an embodiment, the floors are arranged in an eclipsed fashion. This means that the floors, which are arranged at a distance from each other, when looked at from outside in the direction defining that distance, come to lie on top of each other. In an embodiment, at least some of the floors have the same surface area.

In an embodiment, the floors taper in length and/or width from an outermost bottom floor having the largest length and/or width to an outermost top floor having the smallest length and/or width. In an embodiment, tapering in length means that the length and/or width of the floors is increasingly decreasing, such as to generate a pyramidal structure. In an embodiment, the top floor is arranged opposite the bottom floor.

One advantage of these embodiments is that it reproduces the natural dispersion of different species and different life cycle stages of the animals. Furthermore, it allows maximum exploitation of the volume of the tanks relative to the surface area. Additionally, protected spaces are formed in these embodiments, which convey a feeling of safety to the animals. Overall, these embodiments were found to contribute to the animals'well-being and were found advantageous in providing support to the animals, in particular during molting.

In an embodiment, the width of the bottom floor is from 300 mm to 5′000 mm, preferably from 1′000 mm to 2′000 mm. In an embodiment, the width of the top floor is from 100 mm to 1′000 mm, preferably from 200 mm to 500 mm. In an embodiment, the floors have a length from 100 mm to 3′000 mm, preferably from 200 mm to 500 mm, more preferably 300 mm. In a further embodiment, the width and the length of the bottom floor and/or the top floor is determined based on the tank size.

In an embodiment, each support grating comprises a first group of bars arranged parallel to each other and a second group of bars arranged parallel to each other, wherein the bars of the first group cross the bars of the second group at an angle from 20° to 160°, preferably 90°, such that the holes are formed. Preferably, the bars of the first group and the bars of the second group are arranged in the same plane. It is understood that when the bars of the first group cross the bars of the second group at an angle of 90°, the holes thus formed are quadratic. In an embodiment, the bars have a width of less than 20 mm, preferably from 1 mm-7 mm. The width of the bars may preferably define the distance between two adjacent holes. The width of the bars typically extends in the horizontal direction.

One advantage of these embodiments is that they were found particularly advantageous in providing support to the crustaceans, particularly during molting. The indicated ranges for the width of the bars is also sufficiently small to prevent objects, such as food or plants, to be captured by and get stuck on the floors, which would result in at least partial blockage of holes. Additionally, the width of the bars was found to convey sufficient mechanical stability to the substrate structure.

In an embodiment, the interspacing unit is a cylinder, particularly a PVC tube. Preferably, the tube extends parallel to the support gratings. In an embodiment, the interspacing unit is a hollow cylinder, preferably a hollow tube. In an embodiment, the cylinder has an inner diameter from 20 mm to 200 mm, preferably from 50 mm to 150 mm, defining the distance between the floors. These embodiments leads to minimal disruption of water flows and thus contributes to a stable position of the substrate structure even in the presence of currents. Additionally, animals, such as crustaceans being farmed, may swim through the hollow cylinder, e.g. the tube, which contributes to their well-being and protection.

In an embodiment, each support grating comprises a connecting element for releasably connecting two support gratings with each other, wherein the connecting element is arranged on an outer rim of the support grating and wherein the connecting element is preferably a tongue or a groove connection, respectively. In an embodiment, the support gratings are releasably connectable in a form-fit fashion. In an embodiment, each support grating comprises at least one tongue and at least one groove. In an embodiment, the tongue and the groove of each support grating are arranged on the outer rim of the support grating such that two identical support gratings may be connected with each other. Releasably connectable, in this context, means that the structural integrity of the two support gratings to be connected to each other is preserved. It includes multiple connection and disconnection cycles.

One advantage of these embodiments is that it enables facile construction of floors of different sizes. Additionally, identical support gratings may be used as uniform unit, which may be assembled to form substrate structures of different sizes and arrangements.

In an embodiment, the substrate structure further comprises a net/mesh and a ground floor having the largest width and length of all floors, wherein the ground floor is at least partially covered with the net, wherein the net preferably has meshes sized of less than 25 mm². In those embodiments, which comprise a bottom and a top floor, e.g. arranged in a pyramidal fashion, the ground floor is preferably arranged underneath the bottom floor and is the outermost floor. In an embodiment, the ground floor has a width from 1′500 mm to 3′000 mm and a length from 70 mm to 2′000 mm. In a further embodiment, the ground floor has a width and a length, which are selected in dependence of the available tank size. In a further embodiment, the ground floor covers the largest cross sectional extension of the tank. In a further embodiment, the ground floor is planar. When used in a tank, the width and length of the ground floor preferably correspond to the width and length of the bottom of the tank. In an embodiment, at least one, preferably at least two, interspacing units, or other distance elements are arranged underneath the ground floor.

One advantage of these embodiments is that the ground floor serves to collect objects that would otherwise fall to the ground of the tank, such as residual food, plants or molts/exuviae. To remove these objects from the tank, it suffices to remove the substrate structure or to collect them with a clamp from the ground floor, whereas undesired objects such as waste percolating fall underneath the ground floor and can easily be flushed away. Therefore, maintaining and cleaning of the tanks is facilitated. Furthermore, the ground floor may block the bottom part of the tank for the crustaceans being farmed, which makes it possible to remove any waste from the bottom of the tank without interfering with or even harming the crustaceans during the process of waste removal.

In an embodiment, the substrate structure has a plastic surface and is preferably made of plastic, wherein the plastic is preferably any one or any combination of: low-density polyethylene, high-density polyethylene, polypropylene, polyvinyl chloride, polystyrene, polytetrafluoroethylene and polyurethane, particularly polypropylene, polystyrene and polyvinyl chloride, more particularly polyvinyl chloride. In an embodiment, the support gratings have a plastic surface and are preferably made of plastic. In an embodiment, the interspacing units have a plastic surface and are preferably made of plastic.

One advantage of these embodiments is they render the substrate structure waterproof. Additionally, the indicated materials also confer sufficient mechanical stability to the substrate structure. Additionally, the substrate structure of these embodiments possess an advantageous density, such that the substrate structure has a firm position when placed inside a tank filled with water. Specifically, the substrate structure displays an advantageous balance between downforce and buoyancy.

In an embodiment, the support gratings is green. In an embodiment, the interspacing units are black. In an embodiment, the interspacing units, preferably the entire substrate structure, is green. These embodiments were found to contribute to high well-being of the animals, possibly due to emulating the natural environment of the animals.

In a second aspect, the present disclosure relates to a tank entity for crustaceans. The tank entity comprises a tank and a substrate structure as disclosed herein.

In an embodiment, the tank has a volume from 0.25 m³ to 75 m³, preferably from 1 m³ to 4 m³.

In an embodiment, the ground floor of the substrate structure has a surface that is from 90% to 100%, preferably identical to, the surface of the bottom of the tank. In an embodiment, the ground floor covers from 90% to 100% of the surface of the bottom of the tank. This ensures that essentially the entire cross section of the tank may be covered with the substrate structure.

In an embodiment, the substrate structure is arranged inside the tank. In an embodiment, the substrate structure is arranged within 300 mm from the bottom of the tank. In an embodiment, the substrate structure is arranged lower than 10% of the total height of the tank from the top of the tank. In this embodiment, the crustacean is always within the tank/water throughout its lifetime.

In a third aspect, the present disclosure relates to use of the substrate structure disclosed herein, or a tank entity as disclosed herein, for holding crustaceans, particularly macro-crustaceans, more particularly lobsters.

In an embodiment, the substrate structure disclosed herein or the tank entity disclosed herein may be used for farming crustaceans, particularly macro-crustaceans, more particularly lobsters.

In a fourth aspect, the present disclosure relates to a method of holding, preferably farming, crustaceans, preferably lobsters, more preferably spiny lobsters. The method comprises providing a tank filled with water and having crustaceans inside, preferably spiny lobsters. The method further comprises placing a substrate structure as disclosed herein inside the tank, preferably within 300 mm from the bottom of the tank. These two steps may be carried out simultaneously or one after another, wherein both steps may be performed first or second, respectively.

In an embodiment, the method further comprises growing the crustaceans in the tank.

In an embodiment, the crustaceans that are placed inside the tank are in a pre-molt stage or molt stage. The molt stage comprises the time period during which a crustacean molts. The pre-molt stage comprises the 90 days preceding the molting event. The post-molt stage comprises the 5 days succeeding the molting event. In addition, the pre-molt stage is specimen size dependent.

In a fifth aspect, the present disclosure relates to a method of farming molts from crustaceans, which comprises:
the steps of the method of holding crustaceans disclosed herein;
molting of the crustaceans and
collecting the molts.

Crustacean, as used herein, refers to the phylum arthropoda, subphylum crustacean. In an embodiment according to any one of the aspects and embodiments disclosed herein, the crustaceans belong to the order decapoda. In an embodiment according to any one of the aspects and embodiments disclosed herein, the crustaceans are selected from the families nephropidae, palinuridae, astacoidea and parastacoidea. In an embodiment according to any one of the aspects and embodiments disclosed herein, the crustaceans are selected from lobsters, lobsters, crayfish, caridea. Lobster, as used herein, comprises clawed lobsters and spiny lobsters and slipper lobsters. Clawed lobsters, as used herein, comprise the family nephropidae. Spiny lobsters, as used herein, comprise the family palinuridae. Slipper lobsters, as used herein, comprise the family Scyllaridae. In an embodiment according to any one of the aspects and embodiments disclosed herein, the crustaceans are spiny lobsters. In an embodiment according to any one of the aspects and embodiments disclosed herein, the crustaceans are selected from the following: Palinuridae elephas, Palinuridae japonicas, Palinuridae homarus, Palinuridae strimpsoni, Palinuridae guttatus, Palinuridae versicolor, Palinuridae omatus, Palinuridae Jasus, Palinuridae Justitia, Palinuridae Linuparus, Palinuridae Nupalirus.

In an embodiment, the substrate structure includes one or more floats having sufficient buoyancy to prevent the substrate structure from sinking beyond a desired degree when deployed in a body of water. In an embodiment, the substrate structure includes one or more ballasts with weight sufficient to prevent it from floating beyond a desired degree when deployed in a body of water. In an embodiment, the substrate structure includes one or more anchor attachment points.

It is understood that, although the aspects and embodiments of the present disclosure are presented in a specific order and context, the embodiments disclosed herein relate to all aspects of the present disclosure. Additionally, it is understood that the order of at least some of the steps can be altered without deviating from the scope of the disclosure.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described invention will be more fully understood from the detailed description given herein below and the accompanying drawings which should not be considered limiting to the invention described in the appended claims. The drawings are showing:

FIG. 1 shows a perspective view of an embodiment of the substrate structure from an isometric view;

FIG. 2 shows a perspective view of an embodiment of a tank entity;

FIG. 3 shows a front view of the embodiment shown in FIG. 2;

FIG. 4 shows a top view of the embodiment shown in FIG. 2-3;

FIG. 5 shows a first sectional view of the embodiment shown in FIG. 2-4 indicated by section line B;

FIG. 6 shows a second sectional view of the embodiment shown in FIG. 2-5 indicated by section line C;

FIG. 7 shows an embodiment of the method of holding crustaceans disclosed herein.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

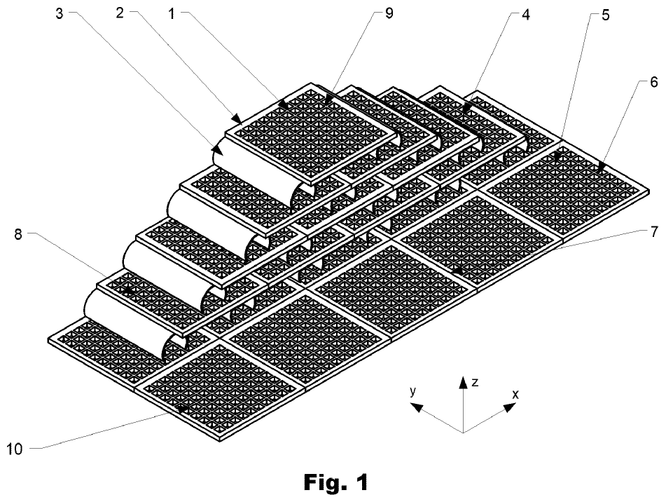

FIG. 1 shows a perspective view of an embodiment of the substrate structure 1. The substrate structure 1 comprises a plurality of support gratings 2, which are arranged parallel to each other. The support gratings 2 lie in a horizontal plane defined by the x-and y-axis. The substrate structure 1 further comprises interspacing units 3, which are arranged between some of the support gratings 2. The support gratings 2 form a total of five floors 4. Each floor 4 comprises between one and ten support gratings 2. The support gratings 2 forming one floor 4 are arranged in the same plane, namely in the plane of the floor 4. The interspacing units 3 are arranged such that the floors 4 are spaced at a distance of 100 mm from each other. The distance between the floors refers to the distance in z-direction.

Each support grating 2 has a size of 30 cm×30 cm and is made in this embodiment of PVC. Each support grating 2 comprises a plurality of bars 6. Half of the bars 6 are arranged parallel to each other and extend in the x-direction, while the other half of the bars are arranged parallel to each other and extend in the y-direction. The bars of the first group cross the bars of the second group at an angle of 90°, such that rectangular cuboid holes 5 are formed having a square cross section. The cross section of the holes is 1 cm×1 cm in size.

Each support grating 2 comprises a plurality of tongues and grooves (not shown in the figures), which are arranged on an outer rim of the support grating 2 and act as connecting elements 7. The support gratings 2 that belong to the same floor 4 are connected to each other by way of the tongues and grooves, which are connectable in a form-fit fashion.

The substrate structure 1 has a bottom floor 8 and a top floor 9 opposite the bottom floor 8. The width of the floors decreases from the bottom floor 8 to the top floor 9, such that a pyramidal shape is formed. In the illustrated embodiment, the top floor 9, the bottom floor 8 and the floors between the top floor 9 and the bottom floor 8 have the same length. The length extends in the y-direction, while the width extends in the x-direction. The bottom floor 8 has a width of 300 mm and a length of 1200 mm. The top floor 9 has a width of 300 mm and a length of 300 mm.

The substrate structure 1 further comprises a ground floor 10 arranged underneath the bottom floor 10. The ground floor 10 is significantly larger than the other floors, including the bottom floor 10. The ground 10 floor may also be covered with a net (not shown). According to this embodiment, the ground floor 10 has a width of 600 mm and a length of 1500 mm.

In the illustrated embodiment, the interspacing units 3 are realized as tubes which are connected to the support gratings 2. As an example, the tubes may be connected to the support gratings 2 by way of a string (not shown). Each support grating 2 is connected to one to two tubes on a bottom face of the support grating 2. To facilitate connecting the tubes and the support gratings 2, the tubes may be cut open.

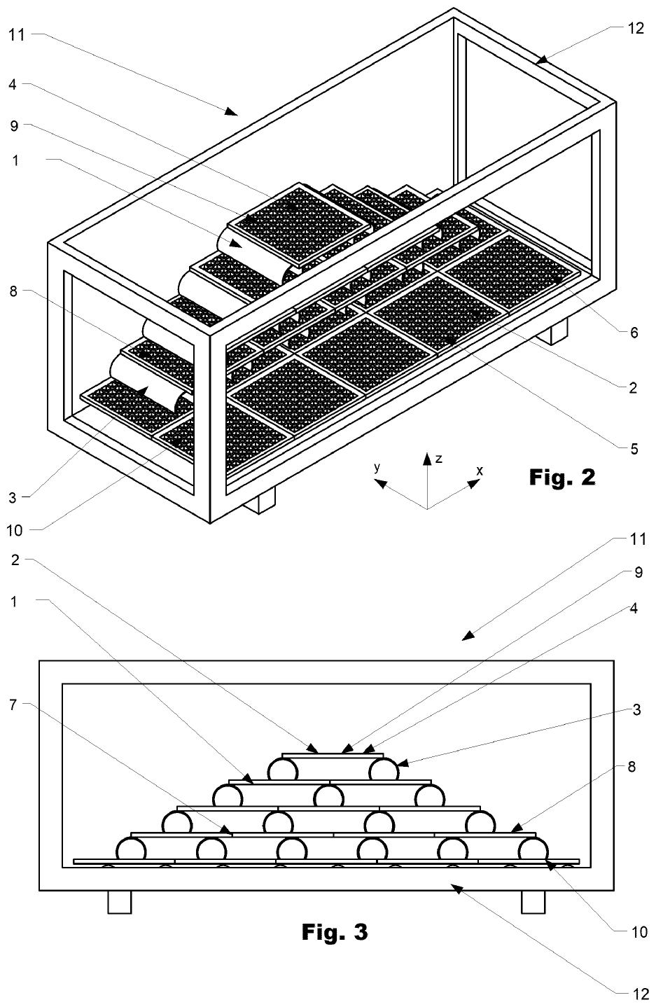

FIG. 2 shows a perspective view of an embodiment of the tank entity 11 disclosed herein. The tank entity 11 comprises a substrate structure 1 and a tank 12. The tank 12 is a rectangular cuboid. The tank 12 has a width of 600 mm, extending in the x-direction. The tank 12 has a length of 1500 mm, extending in the y-direction. The tank 12 has a height of 700 mm, extending in the z-direction.

The tank 12 is filled with water. The substrate structure 1 is located inside the tank 12. In the illustrated embodiment, the ground floor 10 has the same size as the bottom of the tank and the substrate structure 1 rests—by way of the tubes arranged on the bottom of the ground floor 10—on the bottom of the tank 12.

In a further embodiment, the bottom of the tank tapers downwards below the ground floor 10, thereby forming an inverted pyramid shape. This embodiment facilitates collection of waste from the crustaceans, which falls below the ground floor 10 and is collected on the tip of the bottom tank. The ground floor 10, which covers the cross section of the tank 12 is for example arranged above the inverted pyramid shape and separates the area for the crustaceans comprising the support structure 1 from a waste collecting area.

FIG. 3 shows a front view of the embodiment of the tank entity 11 shown in FIG. 2.

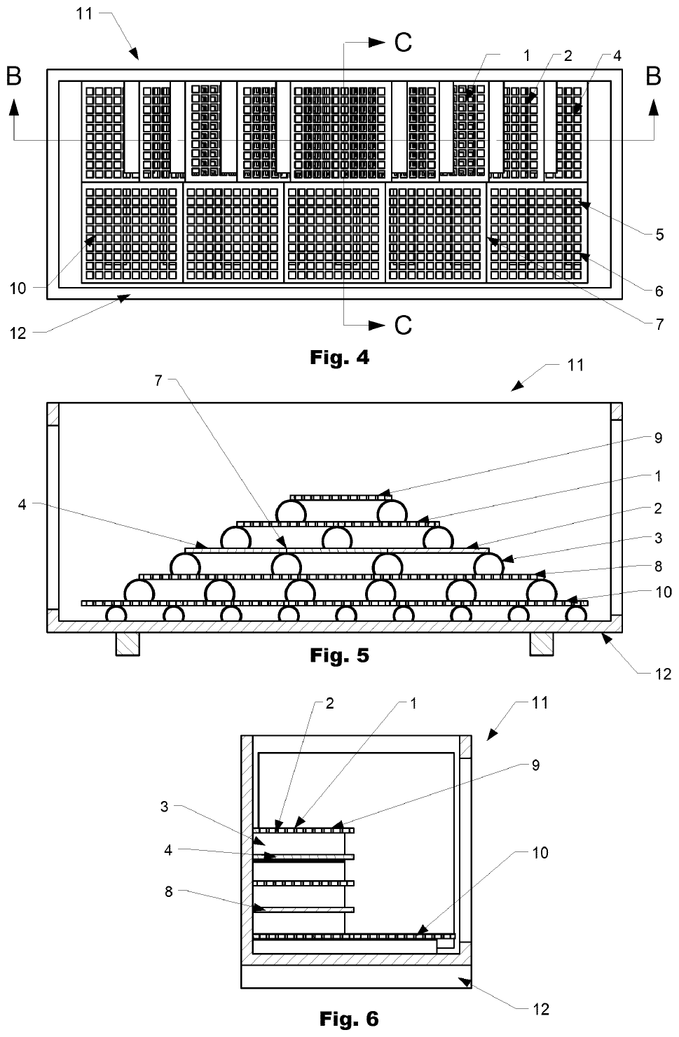

FIG. 4 shows a top view of the embodiment of the tank entity 11 shown in FIGS. 2 and 3.

FIG. 5 shows a first sectional view of the embodiment of the tank entity 11 shown in FIGS. 2-4 indicated by section line B. Section line B is indicated in FIG. 4.

FIG. 6 shows a second sectional view of the embodiment of the tank entity 11 shown in FIGS. 2-5 indicated by section line C. Section line C is indicated in FIG. 4.

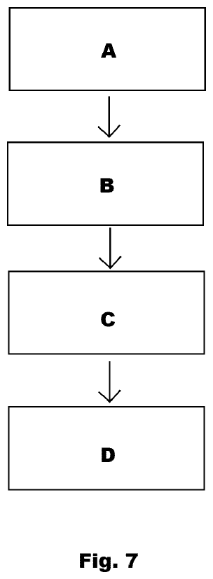

FIG. 7 shows an embodiment of the method of holding crustaceans disclosed herein. The method comprises, as a first step (A), providing a tank 12 filled with water and having crustaceans inside. The method further comprises, as a subsequent step (B), placing the substrate structure 1 inside the tank 12 within 300 mm from the bottom of the tank 12.

In the illustrated embodiment, the method further comprises, as a subsequent step (C), growing the crustaceans. In the illustrated embodiment, the method further comprises, as a subsequent step (D), collecting molts from the crustaceans.

### LIST OF DESIGNATIONS

1 substrate structure
2 support grating
3 interspacing unit
4 floor
5 hole
6 bar
7 connecting element
8 bottom floor
9 top floor
10 ground floor
11 tank entity
12 tank

1. Substrate structure (1) for a tank (12) for crustaceans, wherein the substrate structure (1) comprises:
a. at least two support gratings (2) arranged parallel to each other; and
b. at least two interspacing units (3) arranged between the two support gratings (2) for spacing the two support gratings (2) at a distance of at least 20 mm, such that at least two floors (4) are formed, which provide support for the crustaceans.

2. Substrate structure (1) according to claim 1, wherein the support gratings (2) have holes (5) sized from 1 mm² to 10′000 mm².

3. Substrate structure (1) according to claim 1, wherein the substrate structure (1) comprises a plurality of the support gratings (2) forming three or more of the floors (4), wherein the floors (4) are spaced apart by a plurality of the interspacing units (3).

4. Substrate structure (1) according to claim 1, wherein the floors (4) are spaced apart at a distance from 20 mm to 300 mm.

5. Substrate structure (1) according to claim 1, wherein the floors (4) taper in length and/or width from an outermost bottom floor (8) having the largest length and/or width to an outermost top floor (9) having the smallest length and/or width.

6. Substrate structure (1) according to claim 5, wherein the width of the bottom floor (8) is from 300 mm to 5′000 mm, and wherein the width of the top floor (9) is from 100 mm to 1′000 mm.

7. Substrate structure (1) according to claim 1, wherein the floors (4) have a length from 100 mm to 3′000 mm.

8. Substrate structure (1) according to claim 1, wherein each support grating (2) comprises a first group of bars (6) arranged parallel to each other and a second group of bars (6) arranged parallel to each other, wherein the bars (6) of the first group cross the bars (6) of the second group at an angle from 20° to 160°, such that the holes (5) are formed.

9. Substrate structure (1) according to claim 8, wherein the bars (6) have a width of less than 20 mm.

10. Substrate structure (1) according to claim 1, wherein the interspacing unit (3) is a cylinder.

11. Substrate structure (1) according to claim 10, wherein the cylinder has an inner diameter from 30 mm to 180 mm, defining the distance between the floors (4).

12. Substrate structure (1) according to claim 1, wherein each support grating (2) comprises a connecting element (7) for releasably connecting two support gratings (2) with each other, wherein the connecting element (7) is arranged on an outer rim of the support grating (2).

13. Substrate structure (1) according to claim 1, wherein the substrate structure (1) further comprises a net and a ground floor (10) having the largest width and/or length of all floors wherein the ground floor (4) is at least partially covered with the net.

14. Substrate structure (1) according to claim 1, wherein the substrate structure (1) has a plastic surface and is made of plastic, wherein the plastic is any one or any combination of: low-density polyethylene, high-density polyethylene, polypropylene, polyvinyl chloride, polystyrene, polytetrafluoroethylene and polyurethane.

15. Tank entity (11) for crustaceans comprising a tank (12) and a substrate structure (1) according to claim 1.

16. Use of a tank entity (11) according to claim 15 for holding crustaceans.

17. Use according to claim 16, wherein the crustaceans are spiny lobsters.

18. Substrate structure (1) according to claim 10, wherein the cylinder extends parallel to the support gratings (2).

19. Substrate structure (1) according to claim 12, wherein the connecting element (7) is a tongue or a groove connection.

20. Substrate structure (1) according to claim 13, wherein the net has meshes sized less than 25 mm².
